(19) United States
(12) Patent Application Publication
(10) Pub. No.: US 2011/0249029 A1
(43) Pub. Date: Oct. 13, 2011

(54) System for Manipulating a Detected Object within an Angiographic X-ray Acquisition

(75) Inventor: John Baumgart, Hoffman Estates, IL (US)

(73) Assignee: SIEMENS MEDICAL SOLUTIONS USA, INC., Malvern, PA (US)

(21) Appl. No.: 12/960,632

(22) Filed: Dec. 6, 2010

Related U.S. Application Data
(60) Provisional application No. 61/321,513, filed on Apr. 7, 2010.

(51) Int. Cl. G09G 5/00

(52) U.S. Cl. 345/648; 345/619; 345/649

(57) ABSTRACT

A medical image viewing system comprises an image data processor. The image data processor automatically identifies movement of a particular object within a first image of a sequence of images, relative to the corresponding particular object in a different reference image in the sequence of images. The image data processor automatically determines a transform to apply to data representing the first image to keep the particular object appearing substantially stationary in the first image relative to the corresponding particular object in the reference image, in response to the identified movement. The image data processor stores data, representing the determined transform and associating the determined transform with the first image. A user interface applies the transform acquired from storage to data representing the first image to present the first image in a display showing the particular object substantially stationary relative to the reference image, in response to a user command.

This is a non-provisional application of provisional application Ser. No. 61/321,513 filed Apr. 7, 2010, by J. Baumgart.

### FIELD OF THE INVENTION

This invention concerns a medical image viewing system for automatically determining and applying a transform to data representing a first image to keep a particular object appearing substantially stationary in the first image relative to the corresponding particular object in a reference image, in response to identified movement of the object.

### BACKGROUND OF THE INVENTION

Angiographic X-ray image sequences are acquired for the purpose of examining either some specific piece of anatomy or an implanted device (such as a stent). During this acquisition, the device may move with respect to the X-ray detector. When the user reviews such an image sequence, the object of interest will be moving and blurred. A system according to invention principles addresses this problem and related problems.

### SUMMARY OF THE INVENTION

A system stores attributes of an object common to multiple frames of an angiographic X-ray image acquisition and enables a user to review acquired images such that the object is stationary when the images are reviewed. A medical image viewing system comprises an image data processor. The image data processor automatically identifies movement of a particular object within a first image of a sequence of images, relative to the corresponding particular object in a different reference image in the sequence of images. The image data processor automatically determines a transform to apply to data representing the first image to keep the particular object appearing substantially stationary in the first image relative to the corresponding particular object in the reference image, in response to the identified movement. The image data processor stores data, representing the determined transform and associating the determined transform with the first image. A user interface applies the transform acquired from storage to data representing the first image to present the first image in a display showing the particular object substantially stationary relative to the reference image, in response to a user command.

### BRIEF DESCRIPTION OF THE DRAWING

FIG. 1 shows a medical image viewing system, according to invention principles.

FIG. 2 shows three images with a moving object of interest.

FIG. 3 shows the three images of FIG. 2 transformed such that the detected moving object of interest has the same position, orientation, and size in the three images, according to invention principles.

FIG. 4 shows a system for creation of an object transformation, according to invention principles.

FIG. 5 shows a transformation process using stored transformation coefficients and UI control, according to invention principles.

FIG. 6 shows a flowchart of a process used by a medical image viewing system, according to invention principles.

### DETAILED DESCRIPTION OF THE INVENTION

A medical image viewing system stores attributes of an object common to multiple frames of an angiographic X-ray image acquisition. The system uses the attributes to automatically determine and apply a transform to data representing a first image to keep a particular object appearing substantially stationary in the first image relative to the corresponding particular object in a reference image, in response to identified movement of the object. The system enables a user to review acquired images with the object being stationary when the images are reviewed.

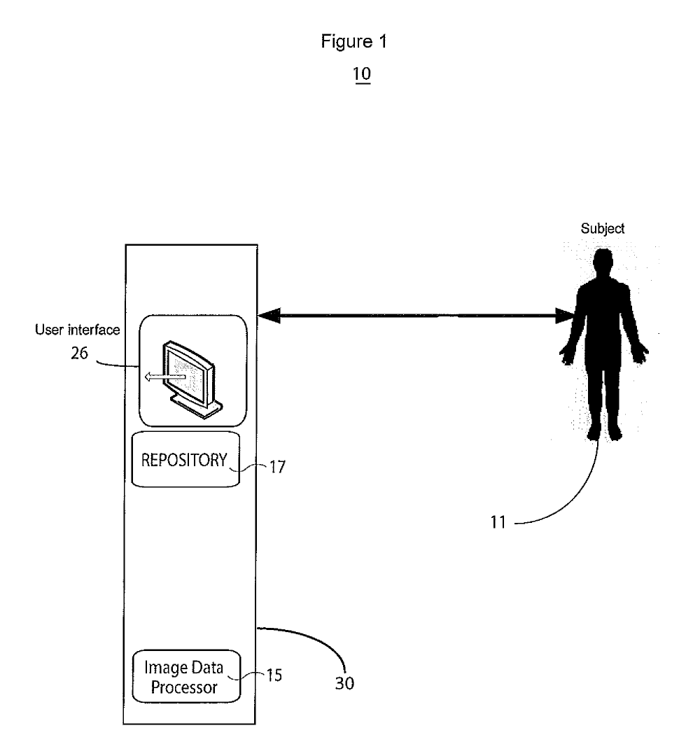

FIG. 1 shows medical image viewing system 10 comprising at least one computer, workstation, server or other processing device 30 including repository 17, image data processor 15 and a user interface 26. Image data processor 15 automatically identifies movement of a particular object within a first image of a sequence of images, relative to the corresponding particular object in a different reference image in the sequence of images. Image data processor 15 automatically determines a transform to apply to data representing the first image to keep the particular object appearing substantially stationary in the first image relative to the corresponding particular object in the reference image, in response to the identified movement. Processor 15 stores data representing the determined transform and associating the determined transform with the first image in repository 17. User interface 26 applies the transform acquired from storage in repository 17 to data representing the first image to present the first image in a display showing the particular object substantially stationary relative to the reference image, in response to a user command.

System 10 uses known feature detection functions to determine the location, orientation and size of the object of interest relative to a desired location, orientation, and size. This desired location, orientation, and size may or may not be that of the object in any one of the images. Image data processor 15 automatically determines an affine transformation to apply to data representing a first image to keep the particular object appearing substantially stationary in the first image relative to the corresponding particular object in a reference image, in response to an identified movement. Processor 15 determines coefficients of the affine transformation and stores the coefficients in repository 17. Image data processor 15 also stores with the image data so that the image can be correctly transformed for display. Processor 15 determines coefficients of affine transformation

x′=c_{0,0}x+c_{0,1}y+c_{0,2}

y′=c_{1,0}x+c_{1,1}y+c_{1,2}

where (x,y) represents the original pixel coordinates and (x′,y′) represents transformed coordinates.

In geometry, an affine transformation or affine transformation map or an affinity between two vector spaces (two affine spaces) consists of a linear transformation followed by a translation. In a finite-dimensional case each affine transformation is given by a matrix A and a vector b, satisfying certain properties. Geometrically, an affine transformation in Euclidean space is one that preserves a collinearity relationship between points, i.e., three points which lie on a line continue to be collinear after a transformation. Also, ratios of distances along a line; i.e., for distinct collinear points p₁, p₂, p₃, the ratio |p₂−p₁|/|p₃−p₂| is preserved. In general, an affine transformation is composed of linear transformations (rotation, scaling or shear) and a translation (or “shift”). Several linear transformations can be combined into a single one, so that the general formula given above is applicable.

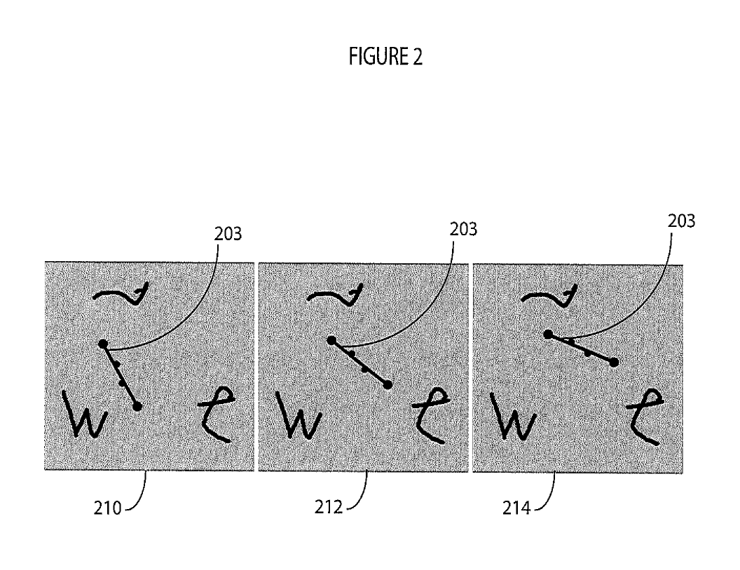

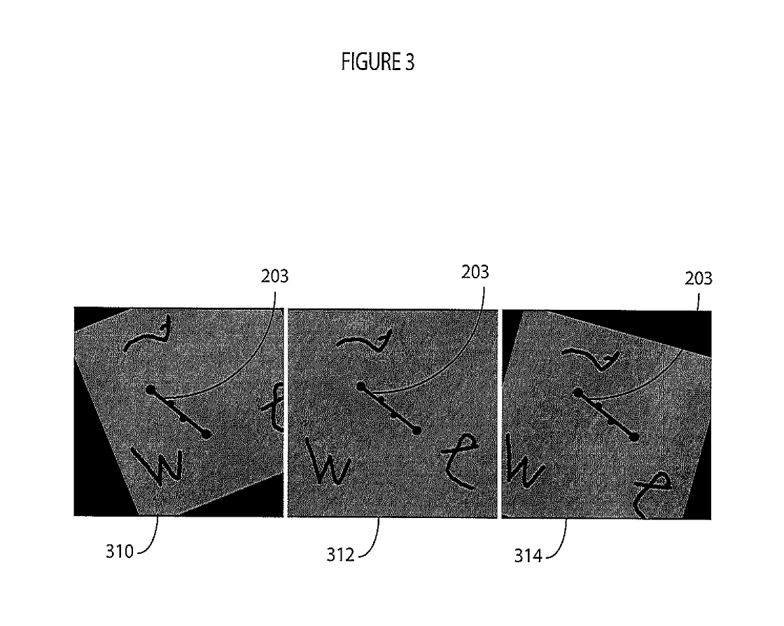

FIG. 2 shows three images with a moving object of interest. When an X-ray image sequence is reviewed, a displayed control element enables a user to choose to either enable or disable application of a stored affine transformation associated with a corresponding image frame being displayed. FIG. 1 illustrates an example of three image frames 210, 212 and 214 each containing detected object 203 (the straight line with a ball at each end) and other information. The object has a different location and orientation in each of the three frames 210, 212 and 214. FIG. 3 shows images 310, 312 and 314 comprised transformed images 210, 212 and 214. The three images of FIG. 2 are transformed such that the detected moving object 203 has the same position, orientation, and size in the three images 310, 312 and 314. The remaining information in images 310 and 314 are shown moving relative to detected object 203.

Image 310 shows a counter-clockwise rotation of image 210 of approximately 22 degrees and a translation upwards of 28 pixels and to the right of 32 pixels. The transformation (inverse mapping) used by processor 15 to provide transformed image 310 by transforming image 210 comprises,

x′=cos(22°)x+sin(22°)y−32

y′=−sin(22°)x+cos(22°)y+28

Processor 15 uses a similar transformation for providing image 314 by transforming image 214 but with a clockwise rotation of 15 degrees and a translation clown of 27 pixels and to the left of 12 pixels. Specifically, image 310 shows a counter-clockwise rotation of approximately 22 degrees. The centre of the object is at coordinates (107,161) in source image 210 and at (147, 148) in destination image 310. The transformation for generating the transformed image from an input image is created from the following forward transformations:

1. Translate the desired centre of rotation of the source to (0,0)

$${A}_{1} = [ \begin{matrix}1 & 0 & 0 \\ 0 & 1 & 0 \\ {t}_{x} & {t}_{y} & 1\end{matrix} ]$$

2. Scale the source image to match the size of the target image

$$S = [ \begin{matrix}{c}_{x} & 0 & 0 \\ 0 & {c}_{y} & 0 \\ 0 & 0 & 1\end{matrix} ]$$

3. Rotate the source image to match the orientation of the target image

$$R = [ \begin{matrix}cos θ & sin θ & 0 \\ - sin θ & cos θ & 0 \\ 0 & 0 & 1\end{matrix} ]$$

4. Translate the centre of rotation from (0,0) to its point on the target image

$${A}_{2} = [ \begin{matrix}1 & 0 & 0 \\ 0 & 1 & 0 \\ {p}_{x} & {p}_{y} & 1\end{matrix} ]$$

The transformation (inverse mapping) is then:

T⁻¹=(A₂RSA₁)⁻¹

Using the numbers in the above example, tₓ=−107, t_{y}=−161, cₓ=1, cₓ=1, θ=22°, pₓ=147, p_{y}=148. The transformation (inverse mapping) is:

$${T}^{- 1} = [ \begin{matrix}0.946 & - 0.354 & 0 \\ 0.354 & 0.946 & 0 \\ 11.263 & - 33.563 & 1\end{matrix} ]$$

The pixels of the destination image, D(x,y) are determined by the pixels of the source image S(x′,y′), where:

x′=0.946x+0.354y+11.263

y′=−0.354x+0.946y−33.563

A similar transformation is used for the image 314, but with values for t, c, and p for image 314.

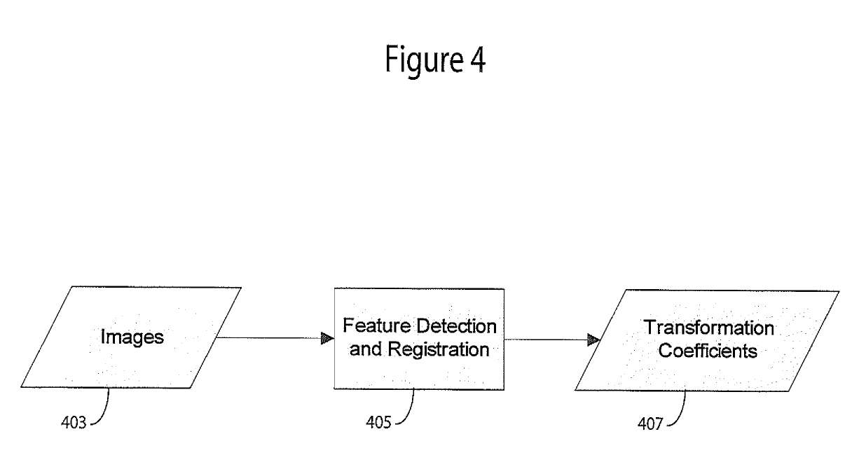

FIG. 4 shows a system for creation of an object transformation and transformation coefficients in response to activation of a transformation by a user via a displayed user-interface image element, such as a button. A button enables a user to toggle between normal display and a motion corrected display provided by applying a transformation to data representing a first image to keep a particular object appearing substantially stationary in the first image relative to a corresponding particular object in a reference image, in response to an identified movement. The first image and reference image are identified in step 403 in response to user entered data. In another embodiment the first image and reference image are identified based on the order in which they were acquired. Processor 15 (FIG. 1) in step 405 aligns the first image and reference image by detecting common stationary elements between the two images. Processor 15 detects an object that moves in the first image relative to a position of the object in the reference image. In another embodiment, a moving object is identified in response to data entered by a user. Processor 15 in step 407 determines translation, rotation and scaling transformations to transform the object in the first image to the position and size the object had in the reference image. Processor 15 uses the determined transformation operations to determine the Affine transformation coefficients in the manner previously described and determine the inverse mapping to apply to the first image to keep the object in fixed position for both reference image and transformed first image.

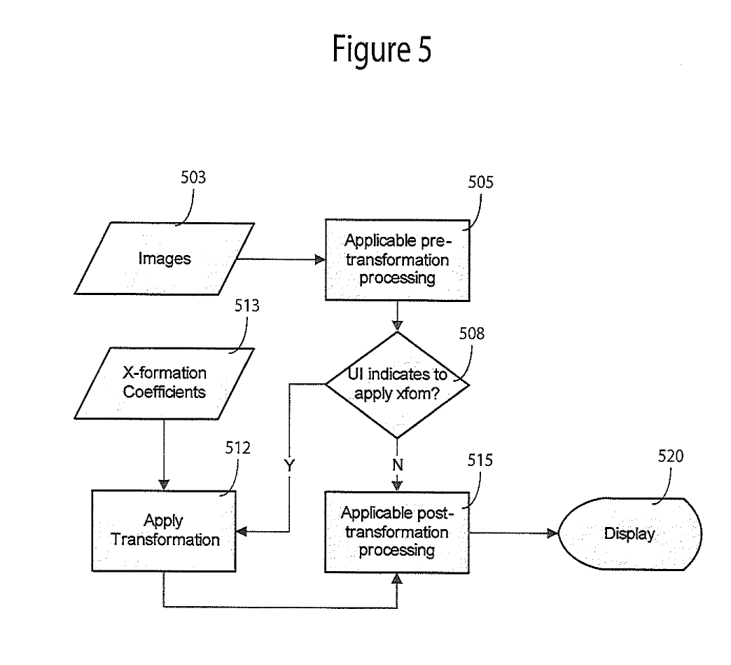

FIG. 5 shows a transformation process using stored transformation coefficients and UI control. Data representing a first image and reference image identified in step 503 in response to user entered data, are pre-processed by processor 15 by filtering and other functions (such as a contrast enhancement function, for example) in step 505. In step 508 in response to user entered data indicating a transformation is to be applied to keep an object stationary between first and reference images, processor 15 (FIG. 1) in step 512 applies a transformation (e.g., Affine transformation) to the pre-processed first image using transformation coefficients acquired from repository 17 in step 513 (previously determined in the process of FIG. 4). The transformed first image is post-processed in step 515 using filtering and edge enhancement and the resultant image is displayed in step 520. If it is determined in step 508 that no transformation is to be applied to keep an object stationary between first and reference images, processor 15 (FIG. 1) post-processes the pre-processed first image in step 515 using filtering and edge enhancement and the resultant image is displayed in step 520. In another embodiment, the order of processing shown in FIG. 5 is altered and the transformation is applied before other postprocessing functions.

In addition to being used to store motion compensation information, the stored transformation coefficients are also used to store alternative transformations selected by a user or in response to other criteria. In one embodiment, the stored transformation coefficients for motion correction apply to 3-dimensional image volume datasets as well as 2-dimensional images. The transformation is adaptive to different sections of an image, which involves storage and use of multiple sets of coefficients for corresponding multiple areas of an image. In this case, processor 15 performs a transformation by interpolating the transformation to apply to a pixel based on proximity of a pixel to known transformations of neighbouring areas of the image. In addition to an affine transformation, coefficients for performing other run-time transformations, such as spherical distortion correction, are stored and applied in this manner.

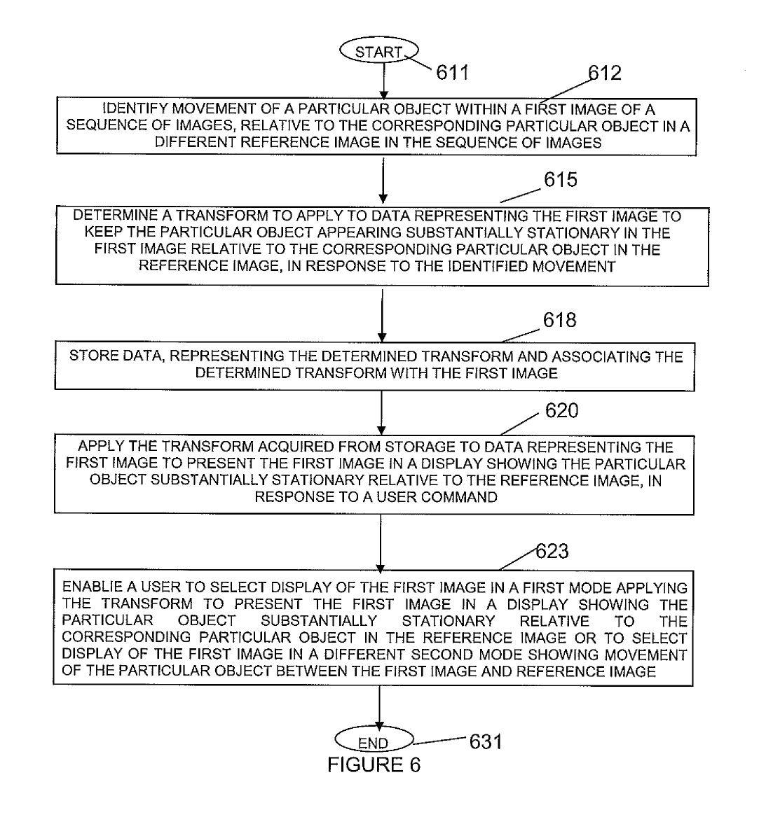

FIG. 6 shows a flowchart of a process used by medical image viewing system 10 (FIG. 1). In step 612 following the start at step 611, image data processor 15 automatically identifies movement of a particular object within a multiple images including a first image of a sequence of images, relative to the corresponding particular object in a different reference image in the sequence of images. In one embodiment, the first image and the reference image are successive images and the reference image occurs substantially at an end of the sequence of images. Processor 15 in step 615 determines one or more transforms (such as an affine transformation) comprising a succession of translation, rotation and scaling operations to apply to data representing the multiple image including the first image to keep the particular object appearing substantially stationary in the first image and the multiple images relative to the corresponding particular object in the reference image, in response to the identified movement. Image data processor 15 determines the translation, rotation and scaling operations as operations transforming a first image so that the particular object matches position and size of the corresponding particular object in the reference image. In step 618, processor 15 stores in repository 17, data representing the one or more determined transforms and associates the determined transforms with the first image.

Image data processor 15 in step 620 applies the transforms acquired from storage to data representing the multiple images including the first image to present the multiple images and first image in a display showing the particular object substantially stationary relative to the corresponding particular object in the multiple images and the reference image, in response to a user command. In response to applying the determined transform, other objects present in both the first image and reference image appear to move relative to the particular object. In a further embodiment, image data processor 15 determines a second transform to apply to data representing the first image to move the particular object in a particular manner and user interface 26 applies the second transform to data representing the first image to move the particular object in the particular manner, in response to user command. In step 623 user interface 26 enables a user to select display of the first image in a first mode applying the transform to present the first image in a display showing the particular object substantially stationary relative to the corresponding particular object in the reference image or to select display of the first image in a different second mode showing movement of the particular object between the first image and reference image. The process of FIG. 6 terminates at step 631.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user

A user interface (UI), as used herein, comprises one or more display images, generated by a user interface processor and enabling user interaction with a processor or other device and associated data acquisition and processing functions. The UI also includes an executable procedure or executable application. The executable procedure or executable application conditions the user interface processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A medical image viewing system uses translation, rotation and scaling operation characteristics to maintain an object stationary between image frames of an angiographic X-ray image sequence by automatically determining and applying a transformation to data representing a first image to keep the object appearing substantially stationary in the first image relative to the corresponding particular object in a reference image. Further, the processes and applications may, in alternative embodiments, be located on one or more (e.g., distributed) processing devices on a network linking the units of FIG. 1. Any of the functions and steps provided in FIGS. 1-6 may be implemented in hardware, software or a combination of both.

What is claimed is:

1. A medical image viewing system, comprising:
an image data processor for automatically,
identifying movement of a particular object within a first image of a sequence of images, relative to the corresponding particular object in a different reference image in the sequence of images,
determining a transform to apply to data representing s first image to keep the particular object appearing substantially stationary in said first image relative to the corresponding particular object in said reference image, in response to the identified movement and
storing data,
representing the determined transform and
associating the determined transform with the first image; and
a user interface for applying the transform acquired from storage to data representing the first image to present the first image in a display showing the particular object substantially stationary relative to the corresponding particular object in said reference image, in response to a user command.

2. A system according to claim 1, wherein
said user interface initiates display of at least one display image presenting user selectable options enabling a user to initiate display of said first image in a first mode and a different second mode,
said first mode including applying the transform to present the first image in a display substantially stationary relative to the corresponding particular object in said different reference image and
said second mode presenting said first image showing said movement of said particular object relative to the corresponding particular object in said different reference image.

3. A system according to claim 1, wherein
in response to applying the determined transform, other objects present in both the first image and reference image appear to move relative to said particular object.

4. A system according to claim 1, wherein
said first image and said reference image are successive images.

5. A system according to claim 1, wherein
said reference image occurs substantially at an end of the sequence of images.

6. A system according to claim 1, wherein
said image data processor,
automatically identifies movement of a particular object within a plurality of images of a sequence of images, relative to the corresponding particular object in a different reference image in the sequence of images,
determines a plurality of transforms to apply to data representing said plurality of images to keep the particular object appearing substantially stationary in said plurality of images relative to the corresponding particular object in said reference image, in response to the identified movement and
stores data,
representing the determined transforms and
associating the determined transforms with corresponding images of said plurality of images and
said user interface applies the transforms acquired from storage to data representing said plurality of images to present said plurality of images in a display showing the particular object substantially stationary in said plurality of images.

7. A system according to claim 1, wherein
the determined transform comprises an affine transformation.

8. A system according to claim 1, wherein
said image data processor determines a second transform to apply to data representing said first image to move the particular object in a particular manner and
said user interface applies the second transform to data representing said first image to move the particular object in the particular manner, in response to user command.

9. A system according to claim 1, wherein
said image data processor determines said transform to apply as a succession of translation, rotation and scaling operations.

10. A system according to claim 9, wherein
said image data processor determines said translation, rotation and scaling operations as operations transforming a first image so that the particular object matches position and size of the corresponding particular object in said reference image.

11. A medical image viewing system, comprising:
an image data processor for automatically,
identifying movement of a particular object within a first image of a sequence of images, relative to the corresponding particular object in a different reference image in the sequence of images,
determining a transform to apply to data representing said first image to keep the particular object appearing substantially stationary in said first image relative to the corresponding particular object in said reference image, in response to the identified movement and
storing data,
representing the determined transform and
associating the determined transform with the first image; and
a user interface for, in response to user command, adaptively,
in a first mode, applying the transform acquired from storage to data representing the first image to present the first image in a display showing the particular object substantially stationary relative to said reference image and
in a different second mode, presenting said first image showing said movement of said particular object relative to the corresponding particular object in said different reference image.

12. A system according to claim 11, wherein
said user interface initiates display of at least one display image presenting user selectable options enabling a user to initiate display of said first image in said first mode and said different second mode.

13. A method employed by at least one processing device for viewing a medical image, comprising the activities of
identifying movement of a particular object within a first image of a sequence of images, relative to the corresponding particular object in a different reference image in the sequence of images;
determining a transform to apply to data representing said first image to keep the particular object appearing substantially stationary in said first image relative to the corresponding particular object in said reference image, in response to the identified movement; and
storing data,
representing the determined transform and
associating the determined transform with the first image; and
applying the transform acquired from storage to data representing the first image to present the first image in a display showing the particular object substantially stationary relative to the corresponding particular object in said reference image, in response to a user command.

14. A method according to claim 13, including the activity of
enabling a user to select display of said first image in a first mode applying the transform to present the first image in a display showing the particular object substantially stationary relative to the corresponding particular object in said reference image or to select display of said first image in a different second mode showing movement of said particular object between said first image and reference image.

15. A method according to claim 13, including the activity of
determining said transform to apply as a succession of translation, rotation and scaling operations.
